(19) United States
(12) Patent Application Publication
(10) Pub. No.: US 2007/0262491 A1
(43) Pub. Date: Nov. 15, 2007

(54) Organic Acid Resistance Improvement in Polymer Coated Metals

(75) Inventors: Adrianus Johannes Den Hartog, Leiden (NL); Hendrik Jacobus Arie Breur, Hoofddorp (NL)

Correspondence Address: STEVENS DAVIS MILLER & MOSHER, LLP, 1615 L STREET, NW, SUITE 850, WASHINGTON, DC, 20036, US

(73) Assignee: CORUS STAAL BV, IJMUIDEN (NL)

(21) Appl. No.: 10/582,773

(22) PCT Filed: Dec. 23, 2004
(86) PCT No.: PCT/EP04/14739

§ 371 Date: Mar. 16, 2007

(30) Foreign Application Priority Data
Dec. 23, 2003 (EP) 03079007.5

(51) Int. Cl. B29C 71/02; B32B 15/08

(52) U.S. Cl. 264/345

(57) ABSTRACT

A method to inhibit the attack by organic acid such as acetic acid, of a thermoplastic polymer coated on a metal container body and/or end. The method includes flash heat treating the whole respective polymer coated metal parts of the container intended to come into contact with the organic acid such that the polymer on the parts is heated to above its melting temperature to make the container suitable for packaging organic acid-containing contents.

The invention relates to a method to inhibit the attack by organic acid such as acetic acid, of a thermoplastic polymer coated on a metal container body and/or end.

Polymer coated metals are developed for a number of applications. One of them is for manufacturing polymer coated metal containers for packaging organic acid containing stuff, such as tuna in white wine sauce.

The aggressiveness of organic acids such as acetic acid is different from that of other substances such as e.g. salt solutions, due to the different interacting mechanism. Whilst a salt-solution will primarily trigger corrosion processes, organic acid solutions are also capable of directly attacking the bond between the metal substrate and the polymer coating layer.

Without heat processing steps like pasteurisation and sterilisation, when packaging organic acid containing stuff, little or no delamination problems are found in spite of the organic acid being very aggressive and likely to attack the interface.

Known polymer coatings are specifically designed to show good adhesion of the coating after deformation.

However, according to the present invention, the problem of attack by organic acids like acetic acid is a more critical factor if the filled containers are heat processed, e.g. sterilised.

Organic acids are capable of diffusing through coatings in their non-dissociated state and the diffusion rate is strongly dependent on temperature (see table 1). At the polymer-metal interface, dissociation can take place and a.o. due to the accumulation of acid, the aggressiveness is high. The acid will have a double effect it enhances corrosion and it detaches the coating.

Especially problematic in connection herewith is the effect of heat processing treatments (retort) used in the packaging of food to increase the storage life. These heat treatments vary with the content and take place at from 80° C. in hot fill applications to more than 120° C. for periods that may well exceed 1 hour.

For example, many fish products packed in cans are sterilised at approx. 115° C. This heat treatment is an important factor in formulating a good product and process to package this type of products.

Presently for packaging such a product no polymer coated metal container is available. Therefore an objective was to find a suitable solution for packaging acetic acid and other organic acid containing stuff that are heat processed, e.g. sterilised.

According to the present invention, heating the container body near the orifice is insufficient to prevent problems associated with packaging organic acid containing stuff that are heat processes, e.g. sterilised.

According to the present invention a specific heat treatment is proposed for all parts making up the container that are made of polymer coated steel and that underwent substantial deformation, i.e. deformation to a degree that there is a risk of weakening of the interface between metal and polymer, e.g. the container body and/or the lid are to the container. The container then becomes resistant to the adverse effects of heat processing such as retorting in the presence of an organic add such as acetic acid. From the experiments it is clear that neither just any nor only a local heat treatment are sufficient.

It is remarked that US2003/0198537 provides a method to inhibit delamination of an extruded thermoplastic polymer coating from a container body by inductively heating the open end of a container body, prior to affixing the can end to the body, to adhere the polymer to the container. A container body is made by forming a cylindrical body having an exterior surface, an interior surface and an edge defining an orifice. The body interior surface is coated with a polymeric liner and the body exterior surface may optionally be decorated. The container body edge near the orifice is inductively heated and an end is joined to the body to form a completed container. According to US2003/0198537, the polymer needs to flow into the microsurface imperfections in the can body interior surface. This already happens above the glass-point of the polymer when the polymer is in the amorphous phase.

According to the present invention however, only a heat treatment above the melting point of the polymer is sufficient to make the coating resistant to organic acid.

The specific use of induction heating to treat the container is not mandatory. It was found that the effect of the invention can also be achieved with a ‘normal’ oven treatment. This also results in the protection of the container. However, a heat treatment by induction (or any other fast heating method or “flash heating”) is advantageous to forestall unwanted degradation and thus resulting embrittlement of the polyester chains in the presence of oxygen.

It was further found according to the invention that it is essential to observe certain time periods for the heat treatment to have optimum effect. From the examples, it is clear that longer periods of time are detrimental and a period of approx. 4 sec was optimal for the packagings under consideration.

Summarising, according to the present invention for a polymer coated metal container to be suitable as a heat processable, e.g. retortable packaging for organic acid containing stuff, it is proposed to heat on the container's inside, the polymer to a temperature above the melt temperature of the polymer during a critical period which should be not too short to have effect and preferably not too long to forestall degradation of the polymer, for conventional polymer coated metal containers preferably in the order of less than 5 seconds.

The invention will now be illustrated using drawings and examples.

In the drawings

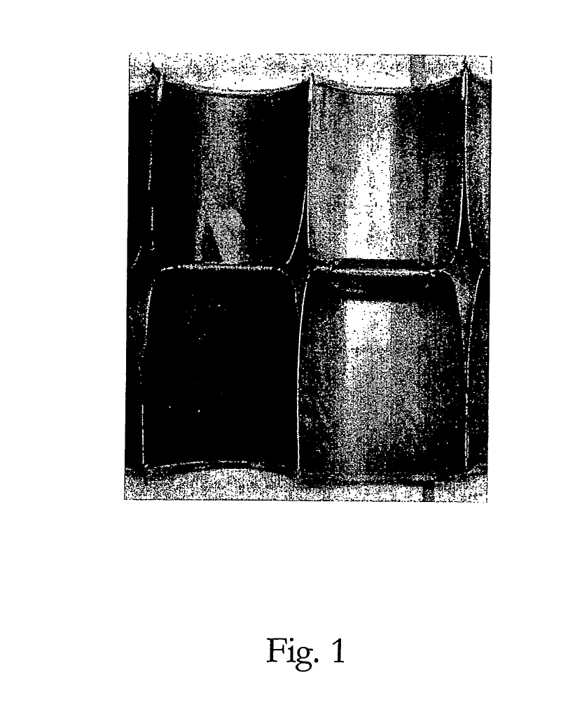

FIG. 1 shows two cans that were exposed to 1.5 wt % acetic acid (c) for 90 minutes at 121° C., one without inductive heat treatment (left) showing heavy delamination and corrosion over the whole surface as is mainly clear from the black colour, and one with inductive heat treatment (right) showing no corrosion or delamination;

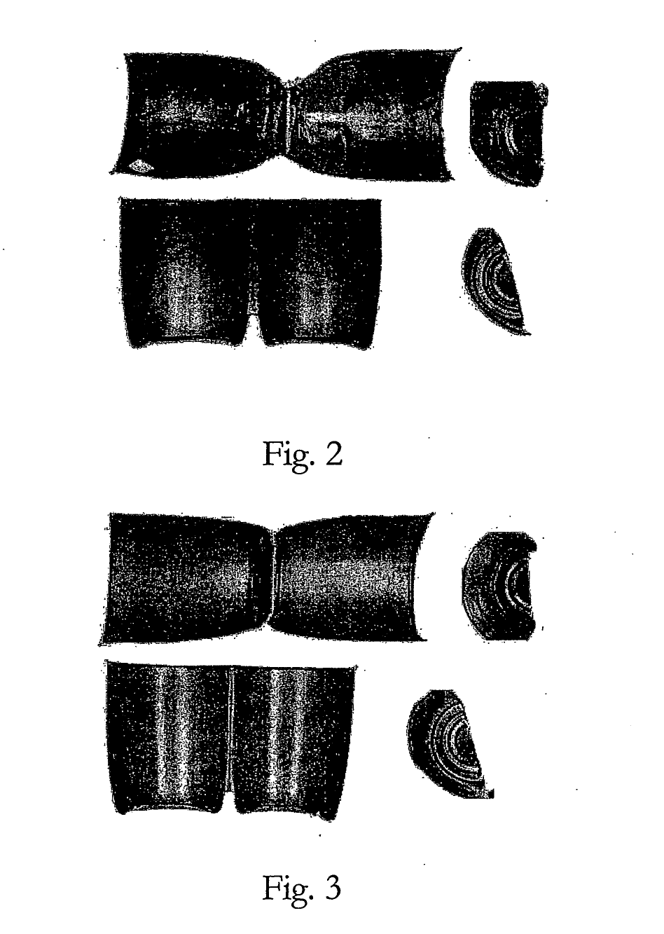

FIG. 2 shows a picture of a cut open non-treated can, the can in the upper picture having been stored 4 months and the lower 1 month containing a filling of 1% HAc solution;

FIG. 3 shows a picture of a cut open can treated in accordance with the invention the can in the upper picture having been stored 4 months and that in the lower 1 month containing a filling of 1% HAc solution;

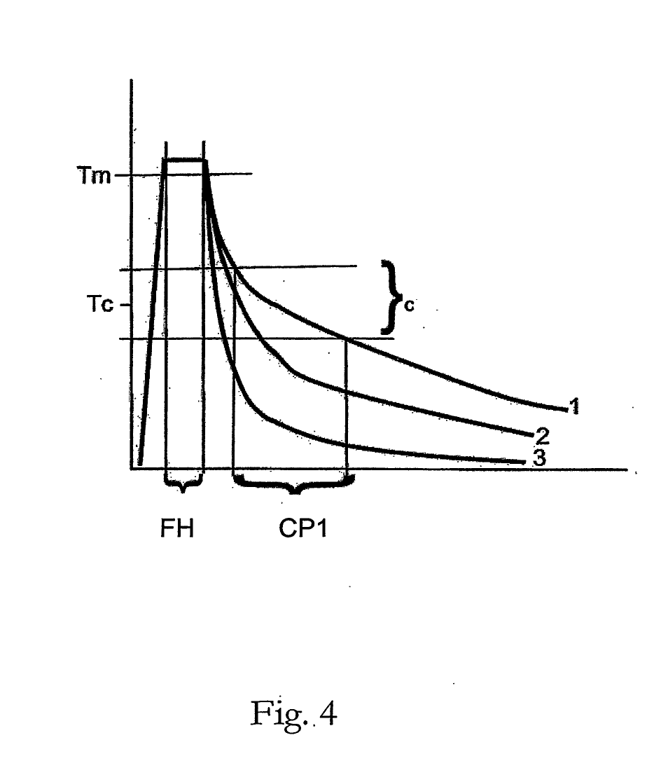

FIG. 4 schematically shows different heat treatments, in particular a flash heat treatment FH according to the invention.

### EXAMPLES

### Example 1

Several factors are of influence on the resistance of polymer coated ECCS packaging steel to organic acids, viz. the type of polymer used because the chemical resistance to acids varies among polymers applied in polymer coated packaging steels, the chromium layer thickness since an increase in layer thickness increases the resistance, the coating thickness since increased coating thickness increases the barrier, the crystallinity of the polymer since increased crystallinity increases the diffusion barrier, additives in the polymer layer which may increase barrier properties and air entrapment since air pockets between coating and substrate are places where acids can accumulate and cause detachment of the polymer from the metal surface.

For flat, non-deformed materials, an optimum combination was found of chromium layer and polymer coating. During subsequent experiments with deformed materials, the positive effects of material choice were lost to a large extent. It was shown that the attack of acetic acid during heat processing occurs at the places with the highest deformation rate, probably resulting from a weakened interface of the polymer and the steel.

Improving the adhesion of the starting material (flat plate) did not improve the performance of the product. It was therefore concluded that the only option to come to a full solution is to strengthen the interface after the making of the container and before filling and heat processing, e.g. retorting.

One option to achieve this is to heat the polymer in an air oven, to enable the binding groups of the polymer to direct themselves to the surface. Experiments were carried out with heating cans made from ECCS coated with PET (in this test DRD cans were used) at several temperatures (ranging from 90 to 260° C., i.e. ranging from slightly above the glass transition temperature to slightly above the melting point of PET) and for several periods (5 min. to 50 minutes) in a hot-air oven. Cans were exposed to 5 wt % acetic acid solutions and pasteurised for 1 hour at 100° C. These experiments showed that the only way to improve performance adequately was to completely melt the polymer to restore the functionality (see table 2).

A problem arising while restoring the functionality by heating the polymer above the melting point was the severe embrittlement of the polymer due to the relatively long residence times at these high temperatures. Even though the adhesion and corrosion resistance was restored, the coating became too brittle and no robust can was the end result. The solution to this problem was found in the use of fast heating methods, herein also referred to as flash heating. Here, inductive heating was used, but other methods are applicable as well. With these heating methods, it is possible to melt the polymer coating of a can within a few seconds.

It was shown that the heated DRD-cans were able to resist sterilisation cycles up to 90 minutes at 121° C. with acetic acid concentrations up to 5 wt % (see table 3).

Analysis of the can wall and bottom showed that the coating itself was not changed to a large extent crystallinity remained the same, orientation was only slightly lower for the DRD-cans. Subsequent crystallisation of the coating again gave a somewhat better result, although much lower than the effect of the melting step.

Diffusion Through Free Film

To assess the migration behaviour of acetic acid through a PET coating, diffusion experiments with free PET coatings at different temperatures were set up. Table 1 shows data regarding diffusion from one compartment of a diffusion cell containing a 3 wt % acetic acid solution to an adjacent compartment containing dematerialized water via a PET foil membrane (osmosis). The data show the importance of temperature on diffusion of acetic acid and organic acids in general on the diffusion coefficient. It also shows why heat treatments of acetic acid containing food are so aggressive to packaging steel.

TABLE 1
Diffusion of acetic acid through a PET foil (20 μm). (Volume cel:
4.40 · 10⁻⁵ m³; Membrane surface: 4.91 · 10⁻⁴ m²) − Diffusion
in 24 hours from compartment A (3% HAc = acetic acid) to
compartment B (de-ionized water).

| | [H₃O⁺] | [HAc] | HAc diffused | HAc diffused | |
|---|---|---|---|---|---|
| | (mole/l) in | (mole/l) in | through film | through film | |
| Temp. | compartment | compartment | in 24 hours | per second | D |
| (° C.) | B after 24 hr. | B after 24 hr. | (mole · m⁻²) | (mole · m² · s⁻¹) | (m² · s⁻¹) |
| 20 | 7.90E−8 | 3.94E−10 | 1.83E−5 | 2.1E−10 | 6.9E−4 |
| 60 | 2.40E−7 | 4.27E−9 | 1.98E−4 | 2.3E−9 | 7.4E−3 |
| 90 | 5.62E−5 | 1.81E−4 | 8.38 | 9.7E−5 | 3.1E+2 |

The diffusion of acetic acid at 20° C. is very low. At increasing temperature the diffusion increases exponentially; at 90° C. the diffusion of HAc through the film is a factor 10,000 higher than at 60° C. This behaviour corresponds to the loss of coating resistance that occurs at temperatures above 60° C. during sterilization of a polymer coated steel DRD-can.

Hot Air Oven Heating of Polymer

Table 2 shows the effects of heat treatments in a standard hot air oven. It shows that the main improvement effect takes place above the melting temperature of the polymer.

TABLE 2
Performance of polymer-coated cans during 60 minutes exposure to
5 wt % acetic acid at 100° C., after heat treating the cans.

| | | | | |
|---|---|---|---|---|
| 5 min. 90° C. | 5 min. 125° C. | 5 min. 170° C. | 5 min. 220° C. | 5 min. 260° C. |
| Poor | Poor | Slightly better | Slightly better | Good, no corrosion visible |
| 10 min. 90° C. | 10 min. 125° C. | 10 min. 170° C. | 10 min. 220° C. | 10 min. 260° C. |
| Poor | Poor | Slightly better | Slightly better | Good, no corrosion visible |
| 25 min. 90° C. | 25 min. 125° C. | 25 min. 170° C. | 25 min. 220° C. | 25 min. 260° C. |
| Poor | Poor | Slightly better | Slightly better | Good, no corrosion visible |
| 50 min. 90° C. | 50 min. 125° C. | 50 min. 170° C. | 50 min. 220° C. | 50 min. 260° C. |
| Poor | Poor | Slightly better | Slightly better | Good, no corrosion visible |

As was mentioned above, although the results here seem acceptable, the embrittlement of the coating makes this method unusable, even at the shortest times used.

Inductive Heating of Polymer

DRD-cans were inductively heated to investigate the melting behaviour of the polymer coating. Table 3 shows the different treatments and their success in melting the polymer.

TABLE 3
Different treatments to melt polymer

| Coating | Inductor | | |
|---|---|---|---|
| thickness | power | Heating | Visual result |
| (μm) | (kW) | time (s) | on polymer |
| 20 | 10 | 4 | Non-melted zone |
| 20 | 10 | 5 | Non-melted zone |
| 20 | 10 | 6 | Non-melted zone |
| 20 | 10 | 10 | Slight yellowing of |
| | | | coating (degradation) |
| 20 | 20 | 2 | Non-melted zone |
| 20 | 20 | 3 | Non-melted zone |
| 20 | 20 | 4 | Good, completely melted |
| 20 | 20 | 5 | Good, completely melted |
| 20 | 20 | 6 | Slight yellowing of |
| | | | coating (degradation) |
| 20 | 20 | 10 | Degradation of coating |
| 20 | 40 | 2 | Slight yellowing of |
| | | | coating (degradation) |
| 20 | 40 | 3 | Slight yellowing of |
| | | | coating (degradation) |
| 30 | 20 | 4 | Non-melted zone |
| 30 | 20 | 5 | Good, completely melted |
| 30 | 40 | 2 | Non-melted zone |
| 30 | 40 | 3 | Good, completely melted |
| 30 | 40 | 4 | Slight yellowing of |
| | | | coating (degradation) |

All fully melted coatings were tested and showed a good resistance to acetic acid solutions, ranging up to 5 wt % acetic acid (tested 1 hour at 100° C.) and 1.5 wt % (tested 90 minutes at 121° C.). For unmelted cans, complete coating detachment occurred in this test and cans turned black due to corrosion product build-up.

In FIG. 1 two cans are shown that were exposed to 1.5 wt % acetic acid for 90 minutes at 121° C. The can without inductive heat treatment deft) shows delamination and corrosion over the whole surface as is mainly clear from the black colour. The can with inductive heat treatment (right) shows no corrosion or delamination.

### Example 2

A series of pack tests was performed to evaluate the results. Two polyester coatings were tested, a transparent and a white PET coating. The steel was coated on both sides with a polyester layer and deep drawn cans were produced from this material. After this, part of the cans were given a flash heat treatment. Experiments A, B, C and D received the flash heat treatment, whereas the control 1 and 2 were not treated.

After this, the cans were either filled directly with the test medium, or received an additional heat treatment. The heat treatments used were a crystallisation step, where the can is heated for 5 minutes at 170° C. or a print simulation.

The crystallisation step results in a PET that is crystallised to its maximal extent. This experiment was performed to evaluate the effect of crystallization on the performance. Also one of the controls (control 2) received this treatment. The simulation of the print curing was done to evaluate effect of ink curing used to decorate the cans. As ink curing time a period of 40 minutes was chosen, which is normal commercial practice, i.e. 20 minutes for the curing of the ink and 20 minutes for the curing of the over-varnish.

The cans were filled with either commercial food products or with simulants containing a chemical that has a strong effect on the performance of the can. After fling and closing of the cans, the cans were sterilised or pasteurised and stored in a temperature-controlled room at 20° C. for 6 months.

The results are given in the following table 4:

| | | | | | Commercial fillings | | | | | | |
|---|---|---|---|---|---|---|---|---|---|---|---|
| | | | | | | 45 min, | Simulants | | | | |
| | | | | | 30 min, | 115° C. | | | | 45 min, | 45 min, |
| | | pretreatments of cans | | | 85° C. | chichar- | 90 min, | 45 min, | 30 min, | 115° C. | 115° C. |
| | type | | crystalli- | print | sour | rillos in | 121° C. | 115° C. | 85° C. | 1% Hac + | 2.5% |
| | material | induction | sation | simulation | pickles | escabeche | 1% HAc | 1% HAc | 1% HAc | 0.4% NaCl | HAc |
| control 1 | transparent | no | | | | 4 | | 1 | 4 | 1 | |
| control 2 | transparent | no | 5 min. | | | 4 | | 2 | 4 | | |
| | | | 170° C. | | | | | | | | |
| exp. A | transparent | yes | | | 5 | 5 | 5 | 4 | 5 | 3 | 2 |
| exp. B | transparent | yes | 5 min. | | 5 | 5 | 5 | 4 | 5 | 4 | 5 |
| | | | 170° C. | | | | | | | | |
| exp. C | transparent | yes | | 40 min. | | 5 | 5 | 5 | 5 | 4 | |
| | | | | 170° C. | | | | | | | |
| exp. D | white | yes | | | 5 | 5 | | 4 | 5 | | |

Escabeche 3 month results only
2.5% Hac 45 min 115° C. 4 months results only, after 6 month perforation
0 = perforation
1 = severe corrosion
2 = heavy corrosion
3 = minor corrosion
4 = almost no corrosion
5 = no corrosion

It is immediately apparent that the flash heat treatment results in a strongly improved performance of the coating in all cases. This is further demonstrated in FIGS. 2 and 3 where a non-treated can and a can treated in accordance with the invention are shown respectively, the can in the upper picture having been stored 4 months and that in the lower 1 month.

Looking at the commercial fillings, the chicharrillos in escabecbe show already corrosion in the untreated cans after 3 months, whereas the treated cans show no corrosion at all.

A crystallisation treatment gives a slight improvement of the performance. This is most strongly seen with the 2.5% HAc.

The observed effects vary with HAc concentration and sterilisation regime in terms of time and temperature. The 2.5% HAc cans performed well after 4 months but after 6 months, all cans had completely corroded, resulting in perforation. No perforation was observed when lower concentrations of acetic acid were used as a filling good.

The results indicate only a very slight difference between the white and the transparent coating.

In FIG. 4 the heat treatment comprising flash heating FH and cooling are illustrated. The horizontal axis represents time and the vertical axis represents temperature. It is important that the period at which the material is above the melting point (Tm) is kept short. In the examples heating periods of several seconds are chosen (including heating up, but excluding cooling down). After the flash heating FH the can is cooled down. Cooling time may vary. Several heat treatment curves are illustrated in FIG. 4 indicated 1, 2 and 3. In example 2, line 3 is applicable. The coated can is cooled rather quickly. During the cooling down, the coating passes through the crystallisation area. For PET the crystallisation temperature Tc is approx. 160° C., depending on various conditions and exact formulation. From FIG. 4 it is clear that the time in this crystallisation region for line 3 is relatively short which will lead to a coating with no or hardly any crystallisation. However, if line 1 is followed, the material is in the crystallisation region for a much longer period. This allows the polyester to crystallise to a greater extent. By choosing the right treatment variant the performance of the can after sterilisation and storage especially in relation with the chosen formulation of the polymer and the composition of the food product can be optimised.

1. A method to inhibit the attack by organic acid of a thermoplastic polymer coated on a metal container body and/or end, said method comprising flash heat treating the whole respective polymer coated metal parts of the container intended to come into contact with the organic acid such that the polymer on said parts is heated to above its melting temperature to make the container suitable for packaging organic acid-containing contents.

2. A method according to claim 1, wherein the polymer is kept above its melting temperature for a period of less than 10 seconds.

3. A method according to claim 1, wherein the polymer is heated to above the melting temperature of the polymer by induction heating.

4. A method according to claim 1, comprising after flash heat treating a step wherein the container is kept at a temperature below the melting temperature of the polymer.

5. A method according to claim 1, wherein the method inhibits the attack by acetic acid of the thermoplastic polymer coated on the metal container body and/or end.

6. A method according to claim 1, wherein the polymer is kept above its melting temperature for a period of less than 5 seconds.

7. A method according to claim 1, comprising after flash heat treating a step wherein the container is kept at a temperature below the melting temperature of the polymer, in a temperature range where crystallization of the polymer occurs.
